(19) United States
(12) Patent Application Publication
(10) Pub. No.: US 2017/0206614 A1
(43) Pub. Date: Jul. 20, 2017

(54) METHOD AND SYSTEM FOR TRADING POWER OF DISTRIBUTED ENERGY RESOURCES

(71) Applicant: Electronics and Telecommunications Research Institute, Daejeon (KR)

(72) Inventors: Tae-In HWANG, Daejeon (KR); Il-Woo LEE, Daejeon (KR)

(21) Appl. No.: 15/410,213

(22) Filed: Jan. 19, 2017

(30) Foreign Application Priority Data
Jan. 20, 2016 (KR) 10-2016-0007068
Sep. 6, 2016 (KR) 10-2016-0114343

(51) Int. Cl. G06Q 50/06; G06Q 40/04

(52) U.S. Cl. CPC G06Q 50/06; G06Q 40/04

(57) ABSTRACT

Disclosed herein is a system for trading power of distributed energy resources, which includes a utility provider electricity meter for measuring an amount of power consumed by a consumer; a distributed resource electricity meter for measuring an amount of power generated by distributed energy resources on the premises of the consumer; and a distributed resource power trade device for calculating an actual amount of power, generated by the distributed energy resources on the premises of the consumer, and comparing same with a contracted amount of power, using measurement data about the amount of generated power, read from the distributed resource electricity meter, and measurement data, read from the utility provider electricity meter.

### CROSS REFERENCE TO RELATED APPLICATIONS

This application claims the benefit of Korean Patent Applications No. 10-2016-0007068, filed Jan. 20, 2016, and No. 10-2016-0114343, filed Sep. 6, 2016, which are hereby incorporated by reference in their entirety into this application.

### BACKGROUND OF THE INVENTION

1. Technical Field

The present invention relates generally to a system and method for trading power of distributed energy resources, and more particularly to technology for trading power generated by distributed energy resources, such as photovoltaic systems, wind turbines, energy storage, emergency power generators, and the like.

2. Description of the Related Art

In existing negawatt markets, consumers contribute to the stabilization of the supply of power merely by reducing the amount of power consumed in load resources, whereas, in a distributed resource power market, consumers may sell power generated using their distributed energy resources, such as photovoltaic systems, wind turbines, Energy Storage Systems (ESS), emergency power generators, and the like, through a utility grid in the energy market.

In such a distributed resource power market, it is essential to precisely measure the amount of power generated by individual distributed energy resources possessed by a consumer. Also, it is necessary to check whether as much power as the contracted amount is actually flowing into a utility grid.

However, in the environment of the existing negawatt markets, because meter data, read from an electricity meter of a utility provider, are collected, and then only the amount of saved power in a load resource is calculated based on a customer baseline load, the amount of power generated by individual distributed energy resources cannot be checked.

Also, if a distributed resource power market is managed using only electricity meters installed in distributed energy resources, power generated by the distributed energy resources on the premises of a consumer flows into a load device such as an energy storage system on the premises of the consumer when a contract is executed, whereby no power or a reduced amount of power may flow to a power grid of the utility provider. Accordingly, it is difficult for the manager of the distributed resource power market to check whether the contracted amount of power generated by the distributed energy resources is actually fulfilled.

### SUMMARY OF THE INVENTION

An embodiment of the present invention intends to provide a system and method for trading power generated by distributed energy resources, configured such that measurement data about the amount of power consumed by a consumer, read from an electricity meter of a utility provider, are compared with measurement data about the amount of power generated by individual distributed energy resources on the premises of the consumer, and such that, if the difference therebetween falls within an acceptable limit, income earned by selling the power is paid to the consumer, but if not, a fine is imposed.

The technical objects of the present invention are not limited to the above-mentioned object, and other technical objects that have not been mentioned will be clearly understood by those skilled in the art from the following description.

A system for trading power of distributed energy resources according to an embodiment of the present invention may include a utility provider electricity meter for measuring an amount of power consumed by a consumer; a distributed resource electricity meter for measuring an amount of power generated by distributed energy resources on premises of the consumer; and a distributed resource power trade device for calculating an actual amount of power, generated by the distributed energy resources on the premises of the consumer, in comparison with a contracted amount of power, using measurement data about an amount of generated power, read from the distributed resource electricity meter, and data read from the utility provider electricity meter.

In an embodiment, the distributed resource power trade device may mediate trade of power of the distributed energy resources in consideration of the measurement data about the amount of power generated by the individual distributed energy resources on the premises of the consumer, which is read from the distributed resource electricity meter, and in consideration of a power usage pattern and a customer baseline load of the consumer, calculated using data about an amount of power consumed by the consumer, which is collected from the utility provider electricity meter.

In an embodiment, the distributed resource power trade device may monitor whether the consumer fulfills a contract, by comparing the actual amount of power, generated by the distributed energy resources, with the contracted amount of power.

In an embodiment, the distributed resource power trade device may determine whether the actual amount of power, generated by the distributed energy resources, falls within an acceptable limit of the contracted amount of power, and may pay income earned by selling power of the corresponding distributed energy resource if the actual amount of power, generated by the distributed energy resources, falls within the acceptable limit of the contracted amount of power, but may impose a fine on the distributed energy resource if the actual amount of power falls out of the acceptable limit of the contracted amount of power.

In an embodiment, the system may further include a meter data gateway for integrating measurement data about the amount of power generated by the distributed energy resources on the premises of the consumer, and delivering the integrated measurement data to the distributed resource power trade device.

In an embodiment, the system may further include a meter data management device for collecting and managing data read from the utility provider electricity meter and the distributed resource electricity meter.

In an embodiment, the distributed resource power trade device may include an administrator interface unit for enabling an administrator to manage registration of the consumer, information about distributed energy resources, and information about a current state of mediation of power trade; a participant interface unit for enabling a participant to apply for admission to a market for trading power of the consumer, registering distributed energy resources of a consumer that becomes a member of the market, and enabling the consumer to manage a bid for power of the distributed energy resources; a process unit for analyzing a consumer load pattern, calculating a customer baseline load, processing a bid and a transaction for power of the distributed energy resources, and settling income earned by selling power, in order to trade power of the distributed energy resources; and a meter data collection interface unit for collecting measurement data about an amount of power consumed by the consumer that becomes a member of the market and measurement data about the amount of power generated by the distributed energy resources of the consumer.

In an embodiment, the process unit may include a consumer load pattern analysis unit for analyzing daily or hourly variation in an amount of power consumed by the consumer in a preset period and determining whether to allow the consumer to participate in a distributed resource power market; a customer baseline load calculation unit for calculating an average hourly load of the consumer for a certain period before a contract for power to be generated by the distributed energy resources is executed; a distributed resource power bid and transaction-processing unit for managing an integrated process of offering, bidding for, and winning a contract for the distributed energy resources of the consumer; and a distributed resource power generation calculation unit for calculating an amount of power generated by distributed energy resources for a contract period, using the measurement data about the amount of generated power.

In an embodiment, the system may further include a distributed resource power sale income settlement unit for determining whether to pay income earned by selling power of distributed energy resources or to impose a fine, using a first value and a second value, the first value may represent a total amount of generated power, collected from the distributed resource electricity meter, and the second value may represent a value acquired by subtracting a value of data, read from the utility provider electricity meter, from a value of the customer baseline load of the consumer.

In an embodiment, the distributed resource power sale income settlement unit may perform a comparison in order to check whether the first value is equal to the second value, and may pay income earned by selling power of the distributed energy resources if a difference between the first value and the second value falls within an acceptable limit, but may impose a fine if the difference falls out of the acceptable limit.

In an embodiment, the meter data collection interface unit may include a utility provider meter data collection unit for collecting measurement data about an amount of power consumed by the consumer from the utility provider electricity meter; and a distributed energy resource meter data collection unit for collecting data about an amount of power generated by individual distributed energy resources from the distributed resource electricity meter.

A method for trading power of distributed energy resources according to an embodiment of the present invention may include determining whether to allow a consumer to participate in a distributed resource power market by analyzing a power load pattern of the consumer; registering an electricity meter on distributed energy resources of the consumer that participates in the distributed resources power market, and performing a metering process for periodically collecting meter data from the registered electricity meter; managing an integrated process of offering, bidding for, and winning a contract for the distributed energy resources of the consumer that participates in the distributed resource power market, and registering and managing a schedule for generating power in accordance with a signed contract; calculating a power usage pattern and a customer baseline load, which is an average hourly load of the consumer for a certain period before a contract for the distributed energy resource is executed; measuring an amount of power consumed by the consumer by reading from a utility provider electricity meter, and measuring an amount of power generated by the distributed energy resources on premises of the consumer by reading from the electricity meter on the distributed energy resources; and settling income earned by selling power of the distributed energy resources in consideration of the power usage pattern of the consumer, the customer baseline load of the consumer, and measurement data about an amount of power generated by the individual distributed energy resources on the premises of the consumer, read from the electricity meter on the distributed energy resources.

In an embodiment, settling the income earned by selling power of the distributed energy resources may be configured to settle the income earned by selling power by determining whether to pay income earned by selling power of distributed energy resources or to impose a fine, using a first value and a second value, the first value may represent a total amount of generated power, collected from the electricity meter on the distributed energy resources, and a second value may represent a value acquired by subtracting a value of data, read from the utility provider electricity meter, from a value of the customer baseline load of the consumer.

In an embodiment, settling the income earned by selling power of the distributed energy resources may be configured to perform a comparison in order to check whether the first value is equal to the second value, and to pay income earned by selling power of the distributed energy resources if a difference between the first value and the second value falls within an acceptable limit, but to impose a fine if the difference falls out of the acceptable limit.

In an embodiment, analyzing the power load pattern of the consumer may be configured to analyze daily or hourly variation in an amount of power consumed by the consumer, to determine whether the variation falls within an acceptable limit, and to decide whether to allow the consumer to participate in the distributed resource power market based on the determination.

In an embodiment, the method may further include managing an integrated process of offering, bidding for, and winning a contract for the distributed energy resource; and registering and managing a schedule for generating power using a contracted distributed energy resource, among the distributed energy resources.

A device for trading power of distributed energy resources according to an embodiment of the present invention may include an administrator interface unit for enabling an administrator to manage registration of a consumer, information about distributed energy resources, and information about a current state of mediation of power trade; a participant interface unit for enabling a participant to apply for admission to a market for trading power of the consumer, registering distributed energy resources of a consumer that becomes a member of the market, and enabling the consumer to manage a bid for power of the distributed energy resources; a process unit for analyzing a power usage pattern of the consumer and calculating a customer baseline load of the consumer, using data about an amount of power consumed by the consumer, and mediating and settling transaction of power of the distributed energy resources in consideration of the power usage pattern, the customer baseline load, and the measurement data about an amount of power generated by individual distributed energy resources on premises of the consumer; and a meter data collection interface unit for collecting measurement data about an amount of power consumed by the consumer that becomes a member of the market and measurement data about the amount of power generated by the distributed energy resources of the consumer.

In an embodiment, the process unit may include a consumer load pattern analysis unit for analyzing daily or hourly variation in an amount of power consumed by the consumer in a preset period and determining whether to allow the consumer to participate in a distributed resource power market; a customer baseline load calculation unit for calculating an average hourly load of the consumer for a certain period before a contract for power to be generated by the distributed energy resource is executed; a distributed resource power bid and transaction-processing unit for managing an integrated process of offering, bidding for, and winning a contract for the distributed energy resources of the consumer; and a distributed resource power generation calculation unit for calculating an amount of power generated by distributed energy resources for a contract period, using the measurement data about the amount of generated power.

In an embodiment, the device may further include a distributed resource power sale income settlement unit for determining whether to pay income earned by selling power of distributed energy resources or to impose a fine, using a first value and a second value, the first value may represent a total amount of generated power, collected from an electricity meter on the distributed energy resources, and the second value may represent a value acquired by subtracting a value of data, read from a utility provider electricity meter, from a value of the customer baseline load of the consumer.

In an embodiment, the distributed resource power sale income settlement unit may perform a comparison in order to check whether the first value is equal to the second value, and may pay income earned by selling power of the distributed energy resources if a difference between the first value and the second value falls within an acceptable limit, but may impose a fine if the difference falls out of the acceptable limit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a system for trading power generated by distributed energy resources according to an embodiment of the present invention;

FIG. 2 is a block diagram of a device for trading power generated by distributed energy resources according to an embodiment of the present invention;

FIG. 3 is a flowchart that shows a method for trading power generated by distributed energy resources according to an embodiment of the present invention; and

FIG. 4 is a block diagram of a computer system to which technology for trading power, generated by distributed energy resources according to an embodiment of the present invention, is applied.

### DESCRIPTION OF THE PREFERRED EMBODIMENTS

Hereinafter, embodiments of the present invention will be described in detail with reference to the accompanying drawings. It should be noted that the same reference numerals are used to designate the same or similar elements throughout the drawings. In the following description of the present invention, detailed descriptions of known functions and configurations which are deemed to make the gist of the present invention obscure will be omitted.

Various terms, such as “first”, “second”, “A”, “B”, “(a)”, “(b)”, etc., can be used to differentiate one component from the other, but the substances, order or sequence of the components are not limited by the terms. Unless defined differently, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

According to the present invention, in order to surveil and mediate power trade by measuring and calculating the amount of power generated by distributed energy resources installed on consumer's premises, such as houses, buildings, factories, and the like, there is provided technology in which the actual amount of power, generated by individual distributed energy resources on the consumer's premises, is calculated and compared with an contracted amount of power in consideration of measurement data about the amount of power generated by the individual distributed energy resources on the consumer's premises and in consideration of a power usage pattern and a customer baseline load of the consumer, calculated using data about the amount of power consumed by the consumer, which is collected from an electricity meter of a utility provider, and then income earned by selling power is paid to the consumer if the actual amount of generated power falls within an acceptable limit of the contracted amount of power, but a fine is imposed if a contract is not fulfilled.

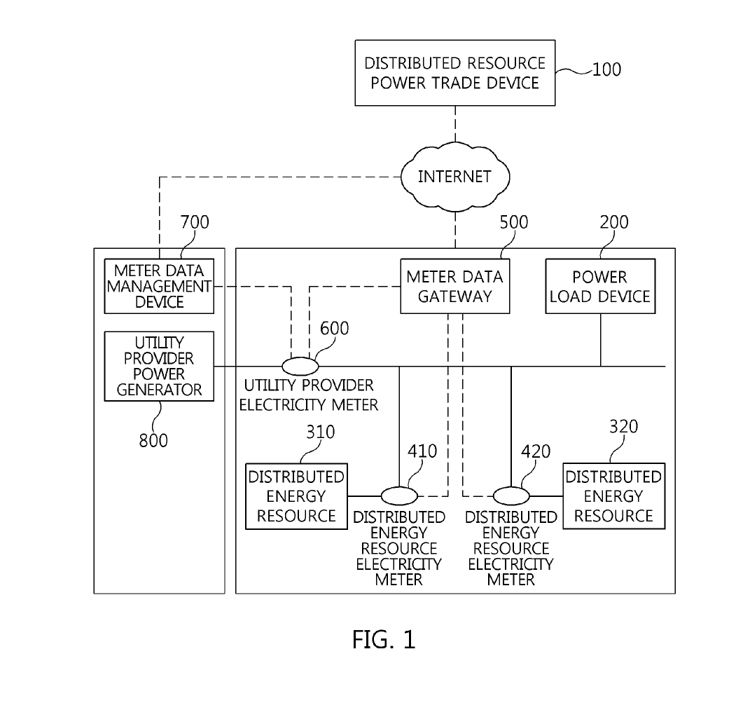

Hereinafter, embodiments of the present invention will be described in detail with reference to FIGS. 1 to 4.

FIG. 1 is a block diagram of a system for trading power generated by distributed energy resources according to an embodiment of the present invention.

Referring to FIG. 1, a system for trading power of distributed energy resources according to an embodiment of the present invention includes a distributed resource power trade device 100, a power load device 200, distributed energy resources 310 and 320, distributed energy resource electricity meters 410 and 420, a meter data gateway 500, a utility provider electricity meter 600, a meter data management device 700, and a utility provider power generator 800.

The distributed resource power trade device 100 mediates trade between energy consumers in order to sell or purchase power of distributed energy resources 310 and 320 possessed by energy consumers, such as houses, buildings, factories, and the like, and measures the amount of power consumed by the energy consumers in order to enable a utility provider to determine whether a contract is fulfilled.

The power load device 200 includes load devices that consume power.

The distributed energy resources 310 and 320 include distributed resources such as photovoltaic systems, wind turbines, energy storage systems, emergency power generators, and the like.

The distributed energy resource electricity meters 410 and 420 measure the amount of power generated by individual distributed energy resources on consumer's premises.

The meter data gateway 500 aggregates measurement data about the amount of power generated by respective distributed energy resources on consumer's premises depending on the route and method through which the measurement data about the amount of generated and consumed power are collected, and transmits the aggregated data to the distributed resource power trade device 100.

The utility provider electricity meter 600 measures the amount of power generated by the utility provider power generator 800.

The meter data management device 700 collects and manages measurement data about the amount of power consumed by an energy consumer, which are periodically read from the utility provider electricity meter 600.

The utility provider power generator 800 includes power generation resources of a utility provider.

When the traded amount of power is checked using only measurement data about the amount of power generated by distributed energy resources possessed by a consumer, it is difficult to check whether as much generated power as a contracted amount is actually supplied to a power grid of a utility provider or is actually consumed by the consumer. Accordingly, in order to solve this problem, the system for trading power of distributed energy resources according to the present invention compares measurement data about the amount of power consumed by a consumer, collected from the utility provider electricity meter 600, with measurement data about the amount of power generated by individual distributed energy resources on the consumer's premises, and pays income earned by selling power if the difference between the amount of generated power and the amount of consumed power falls within an acceptable limit, but imposes a fine if a contract is not fulfilled.

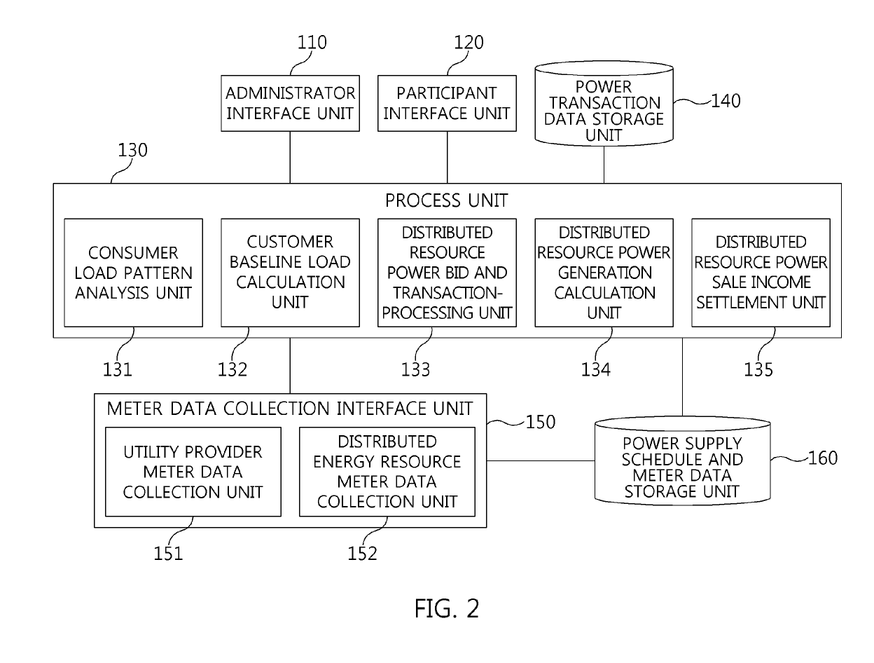

FIG. 2 is a block diagram of a device for trading power generated by distributed energy resources according to an embodiment of the present invention.

Referring to FIG. 2, the distributed resource power trade device 100 according to an embodiment of the present invention includes an administrator interface unit 110, a participant interface unit 120, a process unit 130, a power transaction data storage unit 140, a meter data collection interface unit 150, and a power supply schedule and meter data storage unit 160.

The administrator interface unit 110 manages the registration of a consumer that desires to participate in a distributed resource power market, and provides information about distributed energy resources on the consumer's premises, information about the current state of selling or purchasing of power, and the like to the administrator of the power market.

The participant interface unit 120 provides a consumer who intends to sell or purchase power generated by distributed energy resources by participating in the distributed resource power market with an application form for joining the power market, enables the consumer, having become a member of the power market, to register the distributed energy resources of the consumer and to manage a bid for power of the distributed energy resources, and provides the consumer with information about selling or purchasing of power of the distributed energy resources.

The process unit 130 provides functions of analyzing a consumer's load pattern, calculating a customer baseline load, processing a bid and transaction for power of distributed energy resources, and processing of settlement of income earned by selling power, in order to trade power of distributed energy resources.

To this end, the process unit 130 includes a consumer load pattern analysis unit 131, a customer baseline load calculation unit 132, a distributed resource power bid and transaction-processing unit 133, a distributed resource power generation calculation unit 134, and a distributed resource power sale income settlement unit 135.

The consumer load pattern analysis unit 131 analyzes daily or hourly variation in the amount of power consumed by a consumer, who desires to participate in a distributed resource power market, during a certain period, calculates the variation in order to check whether the variation falls within an acceptable limit, and determines whether to allow the consumer to participate in the distributed resource power market.

The customer baseline load calculation unit 132 calculates the average hourly load of a consumer for a certain period before a contract for power of distributed energy resources is executed.

The distributed resource power bid and transaction-processing unit 133 manages an integrated process of offering, bidding for, and winning a contract for the distributed energy resources of a consumer that participates in the distributed resource power market.

The distributed resource power generation calculation unit 134 calculates the amount of power generated by distributed energy resources for a contract period, using information about the amount of generated power, collected from electricity meters on the distributed energy resource of the consumer.

The distributed resource power sale income settlement unit 135 performs a comparison in order to check whether a first value is equal to a second value. The first value may represent the total amount of generated power, collected from the electricity meters on distributed energy resources. The second value may represent a value acquired by subtracting a value of the meter data of the utility provider electricity meter 600 from the customer baseline load of a consumer. And the distributed resource power sale income settlement unit 135 pays income earned by selling power if the difference between the first value and the second value falls within an acceptable limit, but imposes a fine if not.

The power transaction data storage unit 140 stores information about a consumer that participates in the distributed resource power market, information about the distributed energy resources of the consumer, information about a bid and transaction for distributed energy resources, and information about settlement of income earned by selling power.

The meter data collection interface unit 150 collects measurement data about the amount of power consumed by a consumer that has become a member of the power market and measurement data about the amount of power generated by distributed energy resources of the consumer.

To this end, the meter data collection interface unit 150 includes a utility provider meter data collection unit 151 and a distributed energy resource meter data collection unit 152.

The utility provider meter data collection unit 151 collects measurement data about the amount of power consumed by a consumer from the utility provider electricity meter 600.

The distributed energy resource meter data collection unit 152 collects data about the amount of power generated by respective distributed energy resources from the electricity meters 410 and 420 on the distributed energy resources of the consumer.

The power supply schedule and meter data storage unit 160 stores information about the time at which power of the distributed energy resources is to be supplied and the amount of power to be supplied in accordance with the conclusion of a contract for selling power of the distributed energy resources of a consumer that has become a member of the power market, and stores measurement data about the amount of power consumed by the consumer and measurement data about the amount of power generated by the distributed energy resources.

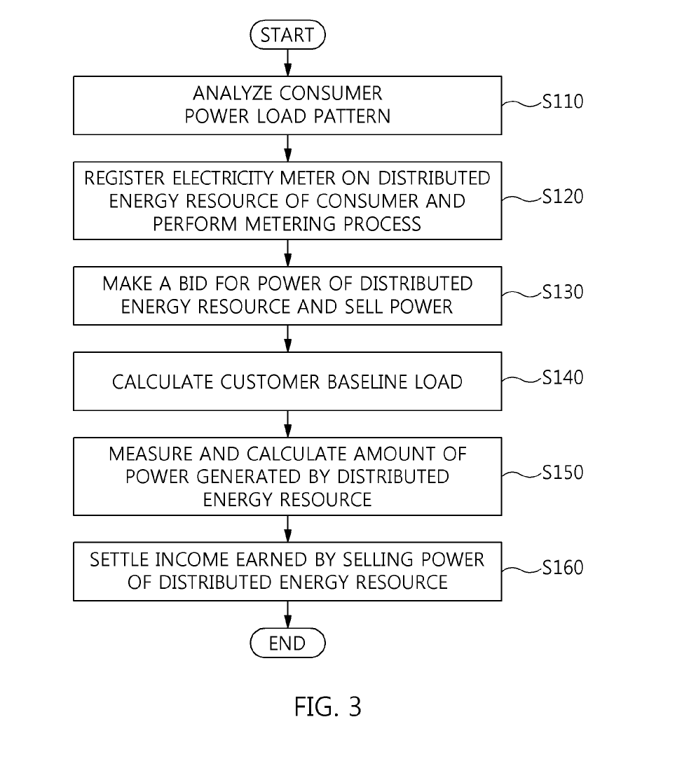

Hereinafter, a method for trading power of distributed energy resources according to an embodiment of the present invention will be described in detail with reference to FIG. 3.

FIG. 3 shows a preferred embodiment of a method for mediating trade between energy consumers in order to sell or purchase power generated by distributed energy resources possessed by energy consumers, such as houses, buildings, factories, and the like, and for monitoring whether a contract is fulfilled normally.

Referring to FIG. 3, a distributed resource power trade device 100 calculates the actual amount of power, generated by individual distributed energy resources on the consumer's premises, compares it with a contracted amount of power, in consideration of measurement data about the amount of power generated by the individual distributed energy resources on the consumer's premises and in consideration of a power usage pattern and a customer baseline load of the consumer, calculated using data about the amount of power consumed by the consumer, which is collected from an electricity meter 600 of a utility provider, and then pays income earned by selling power if the actual amount of generated power falls within an acceptable limit of the contracted amount, but imposes a fine if a contract is not fulfilled.

To this end, first, the distributed resource power trade device 100 analyzes a power load pattern of a consumer that intends to participate in a distributed resource power market at step S110. That is, the distributed resource power trade device 100 analyzes daily or hourly variation in the amount of power consumed by a consumer that intends to participate in the distributed resource power market, checks whether the variation is within an acceptable limit, and determines whether to allow the corresponding consumer to participate in the distributed resource power market, based on the result of checking. In other words, if the variation in the amount of consumed power falls within the acceptable limit, it is determined that the corresponding consumer can participate in the distributed resource power market.

Subsequently, the distributed resource power trade device 100 registers an electricity meter 410 on a distributed energy resource of the consumer that participates in the distributed resource power market, and performs a metering process for periodically collecting meter data from the registered electricity meter 410 at step S120.

Subsequently, the distributed resource power trade device 100 manages an integrated process of offering, bidding for, and winning a contract for the distributed energy resource of the consumer that participates in the distributed resource power market, and registers and manages a schedule for generating power in accordance with a signed contract at step S130.

The distributed resource power trade device 100 calculates the average hourly load of the consumer for a certain period at step S410 before a contract for power to be generated by the distributed energy resource is executed, and calculates the amount of power, generated by the distributed energy resource in a contract period, using information about the amount of generated power, collected from the electricity meter 410 on the distributed energy resource of the customer at step S150.

Subsequently, the distributed resource power trade device 100 performs a comparison in order to check whether a first value is equal to a second value. The first value may represent the total amount of generated power, collected from the electricity meter 410 on the distributed energy resource. The second value may represent a value acquired by subtracting a value of meter data of the utility provider electricity meter 600 from a value of the customer baseline load of the consumer, and pays income earned by selling the power of the distributed energy resource if the difference between the first value and the second value falls within an acceptable limit, but imposes a fine if not, at step S160.

For example, the processes of steps S150 and S160 of FIG. 3 may be described as follows.

If the load on the consumer's premises, expected to be consumed when power is generated according to a contract during a contract period, is 10 kW, if each of two distributed energy resources 310 and 320, possessed by the consumer, generates 10 kW, and if the actual load of the power load device 200 on the consumer's premises for a corresponding period is 10 kW, the measurement data about power consumed by the consumer, read from the utility provider electricity meter 600, is assumed to become −10 kW. Here, if the measurement data about power consumed by the consumer is −10 kW, this indicates that 10 kW power flows into the grid of the utility provider.

First, the distributed resource power trade device 100 checks whether the total amount of generated power, collected from the electricity meters 410 and 420 on the distributed energy resources 310 and 320, matches the value acquired by subtracting measurement data, read from the electricity meter of the utility provider, from the customer baseline load of the consumer, and may thereby check whether the distributed energy resources 310 and 320 fulfill a contract related to the contracted amount of power to generate.

However, because load power frequently changes and because it is difficult to maintain constant load power in the real environment, the measurement data read from the utility provider electricity meter 600 may not be constant but may have error. Accordingly, in order to compensate for such error, the distributed resource power trade device 100 sets a tolerance for the difference from the actual amount of generated power, and pays income earned by selling power of distributed energy resources if the error falls within the tolerance, but imposes a fine if not.

When the tolerance is 12 kW in the above embodiment, if the actual load for the corresponding period becomes 13 kW rather than 10 kW, the contracted amount of power is not satisfied and it is determined that the contract is not fulfilled, whereby the income earned by selling the power is not paid. However, if the actual load for the corresponding period is 11 kW, it is determined that the contracted amount of power is satisfied, whereby the income earned by selling the power is paid normally.

As described above, because an existing negawatt market in the smart grid environment collects only information about meter data read from a utility provider electricity meter and calculates saved power in load resources based on a customer baseline load, the amount of power generated by individual distributed energy resources cannot be checked. If a distributed resource power markets is managed using only an electricity meter installed in distributed energy resources, power generated by the distributed energy resources on the premises of a consumer flows into a load device such as an energy storage system on the premises of the consumer when a contract is executed, whereby no power or a reduced amount of power may flow to a power grid of the utility provider. Accordingly, it is difficult for the manager of the distributed resource power market to check whether the amount of power in accordance with a contract is fulfilled.

In order to monitor and mediate power trade by measuring and calculating the amount of power generated by distributed energy resources installed on consumer's premises, such as houses, buildings, factories, and the like, the present invention calculates the actual amount of power, generated by individual distributed energy resources on the consumer's premises, compares it with a contracted amount of power in consideration of measurement data about the amount of power generated by the individual distributed energy resources on the consumer's premises and in consideration of a power usage pattern and a customer baseline load of the consumer, calculated using data about the amount of power consumed by the consumer, which is collected from an electricity meter of a utility provider, and then pays income earned by selling power if the actual amount of generated power falls within an acceptable limit of the contracted amount, but imposes a fine if a contract is not fulfilled, whereby the consumer may create value by trading power generated by distributed energy resources on the consumer's premises, such as houses, buildings, factories, and the like, through participation in various power trading markets, such as a negawatt market, a distributed resource power market, a Renewable Energy Certificate (REC) market, and the like.

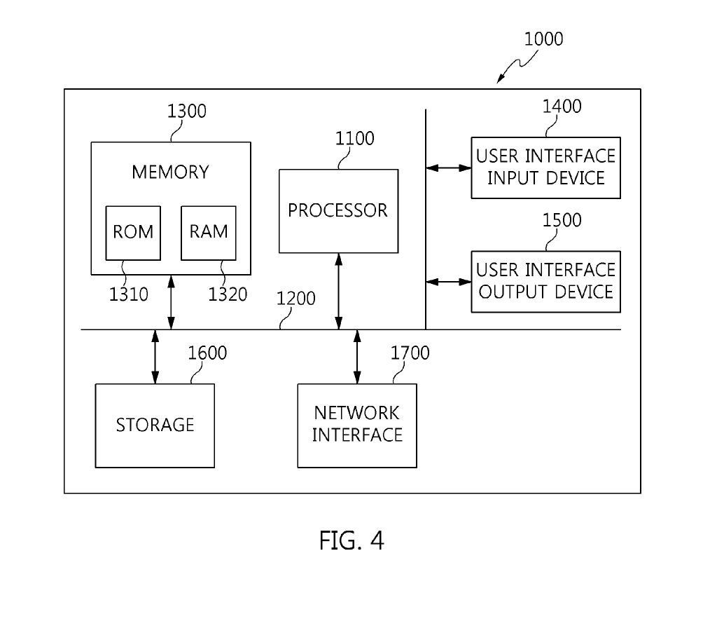

FIG. 4 is a block diagram of a computer system to which technology for trading power, generated by distributed energy resources according to an embodiment of the present invention, is applied.

Referring to FIG. 4, a computing system 1000 may include at least one processor 1100, memory 1300, a user interface input device 1400, a user interface output device 1500, storage 1600 and a network interface 1700, which are connected with each other via a bus 1200.

The processor 1100 may be a central processing unit (CPU) or a semiconductor device for processing instructions stored in the memory 1300 and/or the storage 1600. The memory 1300 and the storage 1600 may include various kinds of volatile or nonvolatile storage media. For example, the memory 1300 may include Read Only Memory (ROM) or Random Access Memory (RAM).

Accordingly, the step of performing the method or the step of executing the algorithm that has been described in connection with the embodiments disclosed in the present specification may be implemented as hardware, a software module or a combination thereof, which is executed by the processor 1100. The software module may be stored in the storage media, such as RAM, flash memory, ROM, EPROM, EEPROM, a register, a hard disk, a removable disk, or CD-ROM, that is, in the memory 1300 and/or the storage 1600.

The exemplary storage media are coupled to the processor 1100, and the processor 1100 may read and interpret information stored in the storage media and write information thereto. In another example, the storage media may be integrated with the processor 1100. The processor integrated with the storage media may be stored in an Application-Specific Integrated Circuit (ASIC). The ASIC may be stored in a user terminal. In other examples, the processor and storage media may be stored in a user terminal as separate components.

According to the present invention, consumers may create value by selling power generated by distributed energy resources on their premises, such as houses, buildings, factories, and the like, by participating in various power markets, such as negawatt markets, distributed resource power markets, Renewable Energy Certificate (REC) markets, and the like.

The above description merely illustrates the technical spirit of the present invention, and those skilled in the art may make various changes and modifications without departing from the scope of the present invention.

Accordingly, the embodiments disclosed in the present invention are intended not to limit but to describe the technical spirit of the present invention, and the scope of the technical spirit of the present invention is not limited to the embodiments. The scope of protection of the present invention must be interpreted based on the accompanying claims, and all the technical spirit in the same range as the claims must be interpreted as being included in the scope of rights of the present invention.

What is claimed is:

1. A system for trading power of distributed energy resources, comprising:
a utility provider electricity meter for measuring an amount of power consumed by a consumer;
a distributed resource electricity meter for measuring an amount of power generated by distributed energy resources on premises of the consumer; and
a distributed resource power trade device for calculating an actual amount of power, generated by the distributed energy resources on the premises of the consumer, in comparison with a contracted amount of power, using measurement data about an amount of generated power, read from the distributed resource electricity meter, and data read from the utility provider electricity meter.

2. The system of claim 1, wherein the distributed resource power trade device mediates trade of power of the distributed energy resources in consideration of the measurement data about the amount of power generated by the individual distributed energy resources on the premises of the consumer, which is read from the distributed resource electricity meter, and in consideration of a power usage pattern and a customer baseline load of the consumer, calculated using data about an amount of power consumed by the consumer, which is collected from the utility provider electricity meter.

3. The system of claim 1, wherein the distributed resource power trade device monitors whether the consumer fulfills a contract, by comparing the actual amount of power, generated by the distributed energy resources, with the contracted amount of power.

4. The system of claim 3, wherein the distributed resource power trade device determines whether the actual amount of power, generated by the distributed energy resources, falls within an acceptable limit of the contracted amount of power, and pays income earned by selling power of the corresponding distributed energy resource if the actual amount of power, generated by the distributed energy resources, falls within the acceptable limit of the contracted amount of power, but imposes a fine on the distributed energy resource if the actual amount of power falls out of the acceptable limit of the contracted amount of power.

5. The system of claim 1, further comprising:
a meter data gateway for integrating measurement data about the amount of power generated by the distributed energy resources on the premises of the consumer, and delivering the integrated measurement data to the distributed resource power trade device.

6. The system of claim 1, further comprising:
a meter data management device for collecting and managing data read from the utility provider electricity meter and the distributed resource electricity meter.

7. The system of claim 1, wherein the distributed resource power trade device comprises:
an administrator interface unit for enabling an administrator to manage registration of the consumer, information about distributed energy resources, and information about a current state of mediation of power trade;
a participant interface unit for enabling a participant to apply for admission to a market for trading power of the consumer, registering distributed energy resources of a consumer that becomes a member of the market, and enabling the consumer to manage a bid for power of the distributed energy resources;
a process unit for analyzing a consumer load pattern, calculating a customer baseline load, processing a bid and a transaction for the distributed energy resources, and settling income earned by selling power, in order to trade power of the distributed energy resources; and
a meter data collection interface unit for collecting measurement data about an amount of power consumed by the consumer that becomes a member of the market and measurement data about the amount of power generated by the distributed energy resources of the consumer.

8. The system of claim 7, wherein the process unit comprises:
a consumer load pattern analysis unit for analyzing daily or hourly variation in an amount of power consumed by the consumer in a preset period and determining whether to allow the consumer to participate in a distributed resource power market;
a customer baseline load calculation unit for calculating an average hourly load of the consumer for a certain period before a contract for power to be generated by the distributed energy resources is executed;
a distributed resource power bid and transaction-processing unit for managing an integrated process of offering, bidding for, and winning a contract for the distributed energy resources of the consumer; and
a distributed resource power generation calculation unit for calculating an amount of power generated by distributed energy resources for a contract period, using the measurement data about the amount of generated power.

9. The system of claim 8, further comprising:
a distributed resource power sale income settlement unit for determining whether to pay income earned by selling power of distributed energy resources or to impose a fine, using a first value and a second value,
the first value represents a total amount of generated power, collected from the distributed resource electricity meter, and
the second value represents a value acquired by subtracting a value of data, read from the utility provider electricity meter, from a value of the customer baseline load of the consumer.

10. The system of claim 9, wherein the distributed resource power sale income settlement unit performs a comparison in order to check whether the first value is equal to the second value, and pays income earned by selling power of the distributed energy resources if a difference between the first value and the second value falls within an acceptable limit, but imposes a fine if the difference falls out of the acceptable limit.

11. The system of claim 9, wherein the meter data collection interface unit comprises:
a utility provider meter data collection unit for collecting measurement data about an amount of power consumed by the consumer from the utility provider electricity meter; and
a distributed energy resource meter data collection unit for collecting data about an amount of power generated by individual distributed energy resources from the distributed resource electricity meter.

12. A method for trading power of distributed energy resources, comprising:
determining whether to allow a consumer to participate in a distributed resource power market by analyzing a power load pattern of the consumer;
registering an electricity meter on distributed energy resources of the consumer that participates in the distributed resource power market, and performing a metering process for periodically collecting meter data from the registered electricity meter;
managing an integrated process of offering, bidding for, and winning a contract for the distributed energy resources of the consumer that participates in the distributed resource power market, and registering and managing a schedule for generating power in accordance with a signed contract;
calculating a power usage pattern and a customer baseline load, which is an average hourly load of the consumer for a certain period before a contract for the distributed energy resource is executed;
measuring an amount of power consumed by the consumer by reading from a utility provider electricity meter, and measuring an amount of power generated by the distributed energy resources on premises of the consumer by reading from the electricity meter on the distributed energy resources; and
settling income earned by selling power of the distributed energy resources in consideration of the power usage pattern of the consumer, the customer baseline load of the consumer, and measurement data about the amount of power generated by the individual distributed energy resources on the premises of the consumer, read from the electricity meter on the distributed energy resources.

13. The method of claim 12, wherein settling the income earned by selling power of the distributed energy resources is configured to settle the income earned by selling power by determining whether to pay income earned by selling power of the distributed energy resources or to impose a fine, using a first value and a second value,
the first value represents a total amount of generated power, collected from the electricity meter on the distributed energy resources, and
the second value represents a value acquired by subtracting a value of data, read from the utility provider electricity meter, from a value of the customer baseline load of the consumer.

14. The method of claim 13, wherein settling the income earned by selling power of the distributed energy resources is configured to perform a comparison in order to check whether the first value is equal to a second value, and to pay income earned by selling power of the distributed energy resources if a difference between the first value and the second value falls within an acceptable limit, but to impose a fine if the difference falls out of the acceptable limit.

15. The method of claim 12, wherein analyzing the power load pattern of the consumer is configured to analyze daily or hourly variation in an amount of power consumed by the consumer, to determine whether the variation falls within an acceptable limit, and to decide whether to allow the consumer to participate in the distributed resource power market based on the determination.

16. A device for trading power of distributed energy resources, comprising:
an administrator interface unit for enabling an administrator to manage registration of a consumer, information about distributed energy resources, and information about a current state of mediation of power trade;
a participant interface unit for enabling a participant to apply for admission to a market for trading power of the consumer, registering distributed energy resources of a consumer that becomes a member of the market, and enabling the consumer to manage a bid for power of the distributed energy resources;
a process unit for analyzing a power usage pattern of the consumer and calculating a customer baseline load of the consumer, using data about an amount of power consumed by the consumer, and mediating and settling transaction of power of the distributed energy resources in consideration of the power usage pattern, the customer baseline load, and the measurement data about an amount of power generated by individual distributed energy resources on premises of the consumer; and
a meter data collection interface unit for collecting measurement data about an amount of power consumed by the consumer that becomes a member of the market and measurement data about the amount of power generated by the distributed energy resources of the consumer.

17. The device of claim 16, wherein the process unit comprises:
a consumer load pattern analysis unit for analyzing daily or hourly variation in an amount of power consumed by the consumer in a preset period and determining whether to allow the consumer to participate in a distributed resource power market;
a customer baseline load calculation unit for calculating an average hourly load of the consumer for a certain period before a contract for power to be generated by the distributed energy resources is executed;
a distributed resource power bid and transaction-processing unit for managing an integrated process of offering, bidding for, and winning a contract for the distributed energy resources of the consumer; and
a distributed resource power generation calculation unit for calculating an amount of power generated by distributed energy resources for a contract period, using the measurement data about the amount of generated power.

18. The device of claim 17, further comprising:
a distributed resource power sale income settlement unit for determining whether to pay income earned by selling power of the distributed energy resources or to impose a fine, a first value and a second value,
the first value represents using a total amount of generated power, collected from an electricity meter on the distributed energy resources, and
the second value represents a value acquired by subtracting a value of data, read from a utility provider electricity meter, from a value of the customer baseline load of the consumer.

19. The device of claim 18, wherein the distributed resource power sale income settlement unit performs a comparison in order to check whether the first value is equal to the second value, and pays income earned by selling power of the distributed energy resources if a difference between the first value and the second value falls within an acceptable limit, but imposes a fine if the difference falls out of the acceptable limit.
